(19) United States
(12) Patent Application Publication
(10) Pub. No.: US 2013/0278966 A1
(43) Pub. Date: Oct. 24, 2013

(54) IMAGE FORMING APPARATUS AND JOB MANAGEMENT METHOD

(71) Applicants: Yuka Saito, Tokyo (JP); Takayuki Inoue, Kanagawa (JP); Kohji Yamamoto, Kanagawa (JP); Daisuke Masui, Kanagawa (JP); Tomoyuki Takahira, Kanagawa (JP); Naohiko Kubo, Kanagawa (JP)

(72) Inventors: Yuka Saito, Tokyo (JP); Takayuki Inoue, Kanagawa (JP); Kohji Yamamoto, Kanagawa (JP); Daisuke Masui, Kanagawa (JP); Tomoyuki Takahira, Kanagawa (JP); Naohiko Kubo, Kanagawa (JP)

(21) Appl. No.: 13/856,596

(22) Filed: Apr. 4, 2013

(30) Foreign Application Priority Data
Apr. 20, 2012 (JP) 2012-096262

(51) Int. Cl. G06K 15/00

(52) U.S. Cl. CPC G06K 15/002
USPC 358/1.15

(57) ABSTRACT

A novel image forming apparatus that categorizes print job information for each newly added application and presents the print job information without categorizing data incorrectly and mixing in impersonation data. All of the applications that installed additionally extract jobs that went through itself only from trace information on jobs notified by the default functions and display it in a user interface. The trace information on jobs is a job ID association list that associates a job ID numbered by the default functions with a job ID of a job issued by the additional application.

### CROSS-REFERENCE TO RELATED APPLICATION

This patent application is based on and claims priority pursuant to 35 U.S.C. §119 to Japanese Patent Application No. 2012-096262, filed on Apr. 20, 2012 in the Japan Patent Office, the entire disclosure of which is hereby incorporated by reference herein.

### BACKGROUND

1. Technical Field

The present invention relates to an image forming apparatus and a job management method that facilitate installing additional applications.

2. Background Art

In the technical field of image forming apparatuses, a technology that stores trace information (job status, error, print history information, etc.) of executed print jobs and requested print jobs and presents that information to users by displaying that information on a user interface such as a control panel is well known.

With some image forming apparatuses, it is possible to install multiple additional applications newly developed after shipment of the image forming apparatus. For example, a technology in which newly added application can execute printing and display information on a user interface such as a control panel using the default printing function with which the image forming apparatus is equipped has been proposed (e.g., JP-2005-269619-A.)

Similarly, an image forming apparatus that can install not only new applications developed by the vendor of the image forming apparatus after shipment of the image forming apparatus but also applications developed by third-party vendors is also well known.

Conventionally, an image forming apparatus that can install additional applications could not properly display information on print jobs sent from the application. In particular, information on print jobs could not be displayed as information separately for each newly added application. This deficiency is presumed to happen because print jobs sent from the new applications are merged with print jobs sent from other applications and drivers on a network upon transfer of the job to the default printing function and cannot be distinguished from them.

To avoid this problem, a technology in which a user or an newly added application adds specific identifying information (e.g., an identifier) to jobs in order to classify jobs for each such application has been proposed (e.g., JP-2009-105753-A.) However, where there are multiple new applications developed by a plurality of different vendors and there is no mechanism by which they can cooperate with each other and those applications are installed/uninstalled as needed, there is a possibility that identifying information is allocated redundantly by different users or by different new applications and jobs cannot be categorized correctly.

Print data that does not go through additional applications (e.g., print data that a personal computer sends to a print port of the image forming apparatus directly) can be processed in any way. Therefore, if identifier of a specific application is known, it is easy to pretend as if printing from that specific application in the technology disclosed in JP-2009-105753-A.

In the technology disclosed in JP-2009-105753-A, the problem is how to implement output job control in accordance with a desired order of output, and a method that categorizes jobs using identifiers for each application is taught. However, possibilities of categorizing data incorrectly due to redundant identifiers, etc., and impersonation as described above still cannot be solved by this method.

### SUMMARY

The present invention provides a novel image forming apparatus that categorizes print job information for each newly added application and presents the print job information without categorizing data incorrectly and mixing impersonation data in.

More specifically, the present invention provides an image forming apparatus that includes a printer control application that controls an image forming operation, an additional application print control unit that submits a print job to the printer control application, a plurality of additional applications that submit a print job to the additional application print control unit, and a user interface using service that includes an interface available for the additional applications. Each of the additional applications includes a job list that lists jobs submitted to the additional application print control unit and provides information for each job to the user interface via the user interface using service based on the job list. The additional application print control unit assigns a unique ID number for each submitted job, submits the numbered job to the printer control application, associates the numbered job with a job ID of a print job managed by the printer control application, receives a job event from the printer control application along with the job ID, and broadcasts the received job event to all of the additional applications along with the job ID associated with the received job ID. After receiving the job event along with the job ID, each additional application determines whether or not the received job ID is on its job list, ignores the job event if the received job ID is not on the job list, updates the job list based on the job event if the received job ID is on the job list, and provides information on each job to the user interface via the user interface using service based on the job list.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating a configuration as an embodiment of the present invention.

FIG. 2 is a block diagram illustrating a configuration as an embodiment of the present invention.

FIG. 3 is a sequence diagram illustrating a printing process executed by the additional application A in FIG. 1 as an embodiment of the present invention.

FIG. 4 is a diagram illustrating a job ID associating list 150 in FIG. 2 as an embodiment of the present invention.

FIG. 5 is a diagram illustrating a job ID associating list 153 in FIG. 2 as an embodiment of the present invention.

FIGS. 6A, 6B, 6C, and 6D are diagrams illustrating a job list 152 in FIG. 2 as an embodiment of the present invention.

FIG. 7 is a flowchart illustrating a process of an additional application related to FIGS. 6A and 6B as an embodiment of the present invention.

FIG. 8 is a flowchart illustrating a process of an additional application related to FIGS. 6C and 6D as a second embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

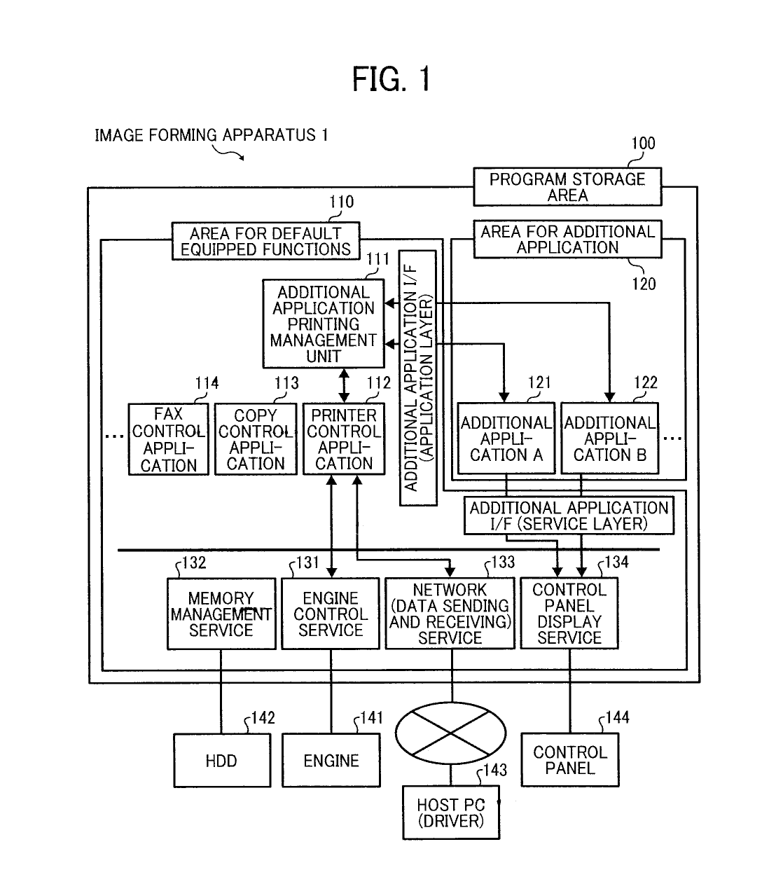

FIG. 1 is a block diagram illustrating a configuration as an embodiment of the present invention. In FIG. 1, an image forming apparatus 1 includes functional units such as an engine 141 as a hardware functional unit for printing and forming an image, a hard disk drive (HDD) 142 as a sub-storage device, and a control panel 144 as a displaying unit as a user interface. The image forming apparatus 1 is connected to a host personal computer (PC) 143 on a network via a data communications network.

From a software configuration point of view, the active image forming apparatus 1 includes a program storing area 100 in its main memory. The program storing area 100 includes software programs in two prominent layers, a service layer and an application layer. For example, programs in the service layer include an engine control service 131 that controls the engine 141 of the hardware functional units, a memory control service 132 that controls the HDD 142 of the hardware functional units, and a control panel displaying service 134 that controls the control panel 144.

Other examples of programs in the service layer include a network (data sending/receiving) service 133 that communicates with the host personal computer 143 via the network. More specifically, it dialogues with a driver that controls the image forming apparatus 1 installed in the host personal computer (PC) 143 programmatically.

Programs in the application layer include applications installed in the image forming apparatus 1 as defaults at the time of shipment and other applications. The latter applications are referred to as additional applications. The vendor of the image forming apparatus 1 develops some of the additional applications newly after shipment, and other additional applications are developed by third party vendors and installed additionally.

Examples of applications installed as defaults at the time of shipment are a printer control application 112, a copy control application 113, and a fax control application 114. The applications installed as defaults at the time of shipment are not limited to applications mentioned above. In this embodiment, the image forming apparatus 1 further includes an additional application print control unit 111 that acts as an interface between the additional applications and applications installed as default at the time of shipment.

Applications installed as defaults at the time of shipment are loaded in an area for default equipped functions 110. In FIG. 1, all of programs in the service layer are equipped as defaults at the time of shipment and are loaded in the area for default equipped functions 110.

By contrast, installed additional applications are loaded in an area for additional applications 120. It is to be noted that although in FIG. 1 additional application A 121 and additional application B 122 are installed the number of installed additional applications is not limited to two.

An example operation of the printer control application 112 such as controlling printing in normal printing mode is described below.

After the host PC 143 sends a print job to the image forming apparatus 1 via the network, the network (data sending/receiving) service 133 receives the print data, the printer control application 112 analyzes print job, etc., and the engine control service 131 is commanded to execute printing and ejecting paper, etc.

The printer control application 112 can display information (e.g., “Now printing” and “Toner remaining amount”) on the control panel 144 using the control panel displaying service 134.

As described above, the programs in the application layer have programs in the service layer operate in combination accordingly and acquire desired processing results.

Meanwhile, additional applications also execute predefined processing using programs in the service layer and programs equipped as defaults at the time of shipment (i.e., functions equipped at the time of shipment).

The control panel displaying service 134 includes an interface for additional applications. The additional applications command the control panel displaying service 134 to display information on the control panel 144.

In the application layer, the additional application printing management unit 111 acts as an interface for additional applications. The additional applications command the additional application printing management unit 111 to execute printing and have the engine 141 execute printing and ejecting paper, etc,. via the printer control application 112 and engine control service 131.

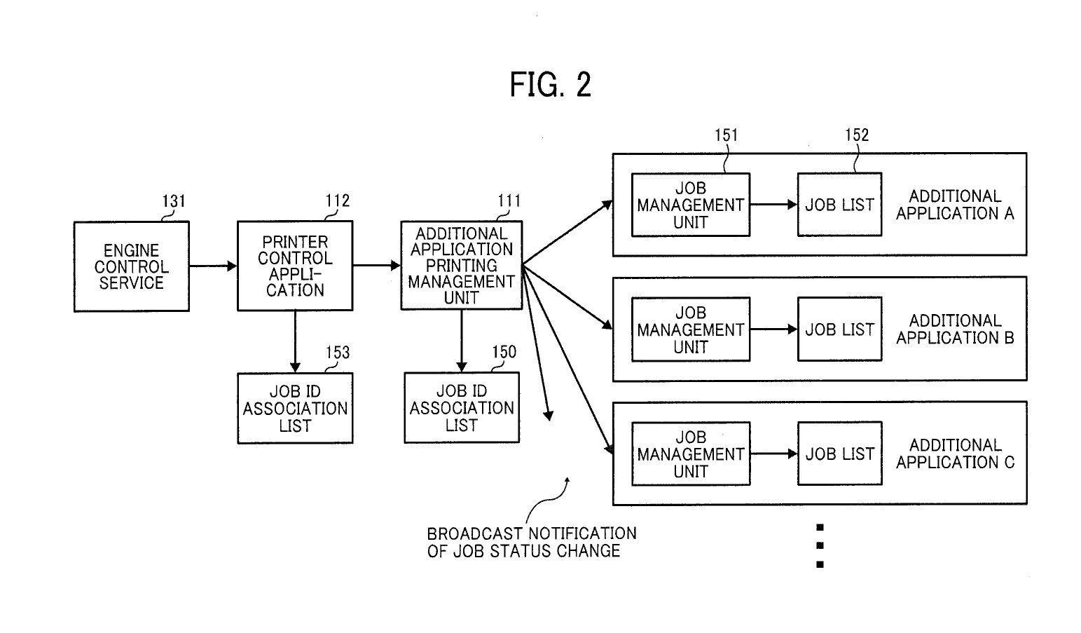

FIG. 2 is a block diagram illustrating a configuration in this embodiment. As shown in FIG. 2, the additional application printing management unit 111 includes a job ID association list 150 and manages correspondences between ID of jobs issued to the printer control application 112 and ID of jobs issued by additional applications.

Also, the printer control application includes a job ID association list 153 and manages correspondences between ID of jobs issued to the engine control service 131 and ID of jobs issued to the printer control application 112.

Also, each additional application includes a job management unit 151 and a job list 152. The job list 152 is a list of jobs that the additional application issued to the additional application printing management unit 111. The job management unit 151 updates the job list 152.

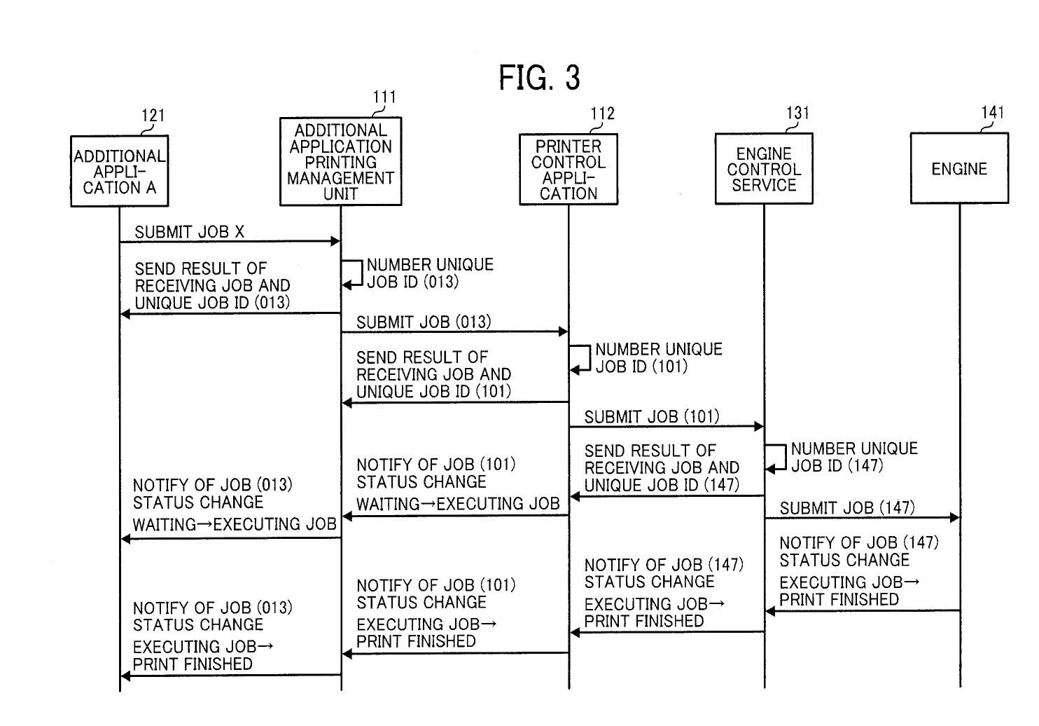

FIG. 3 is a sequence diagram illustrating a printing process executed by the additional application A 121 using functions equipped in the image forming apparatus 1 as defaults at the time of shipment.

Firstly, the job management unit 151 issues a job to the additional application printing management unit 111 with undetermined ID. The additional application printing management unit 111 numbers the issued job, preferably with a unique ID .

After numbering, the additional application printing management unit 111 returns the numbered job ID along with the result of accepting the job to the additional application that issued the job with an undetermined ID. The job management unit 151 adds the numbered job ID to the job list 152.

In FIG. 3, a unique job ID is numbered after the additional application A 121 issued a job x, and the result of accepting the job is returned along with the numbered job ID.

After the additional application printing management unit 111 issues the numbered job to the printer control application 112 along with the job ID, the printer control application 112 numbers a unique value for the job ID and returns the numbered job ID to the additional application printing management unit 111 along with the result of accepting the job. The additional application printing management unit 111 associates the returned job ID with the job ID that the additional application printing management unit 111 issued and adds them to the job ID associating list 150.

In FIG. 3, the additional application printing management unit 111 issues the job (013), a unique job ID (101) is numbered, and the numbered job ID is returned along with the result of accepting the job.

The printer control application 112 issues the numbered job to the engine control service 131 along with the job ID. Subsequently, the engine control service 131 numbers a unique value for the job ID and returns it to the printer control application 112 along with the result of accepting the job. The printer control application 112 associates the returned job ID with the job ID that the printer control application 112 issued and adds them to the job ID associating list 153.

In FIG. 3, the printer control application 112 issues the job (101), a unique job ID (147) is numbered, and the numbered job ID is returned along with the result of accepting the job.

After issuing the job to the engine control service 131, at the time of receiving the accepting result, the printer control application 112 notifies the additional application printing management unit 111 of a change of the issued job status. In FIG. 3, the printer control application 112 notifies of changing status from “waiting” to “executing job”.

After receiving the notification for the status change, the additional application printing management unit 111 broadcasts the changing notification to all of the additional applications using the job ID related to the corresponding job ID.

After receiving the notification of the status change, each additional application refers to its own job list 152 and updates the job list 152 only if the status change of the job ID included in the job list 152 is notified. Otherwise, the additional application ignores the notification.

On the other hand, the engine control service 131 issues the job that the engine control service 131 numbered its job ID to the engine 141 and has the engine 141 process the job controlling the engine 141. After the engine 141 finishes processing and notifies of the status change (e.g., from “executing job” to “print finished”), the engine control service 131 notifies the printer control application 112 of the status change along with the corresponding job ID.

After receiving the notification of the status change, the printer control applications specifies the job ID corresponding to the received job ID referring to the job ID association list 153 and notifies the additional application printing management unit 111 of the status change along with specified job ID.

After receiving the notification of the status change, the additional application printing management unit 111 specifies the job ID corresponding to the received job ID referring to the job ID association list 150 and broadcasts the status change to all of the additional applications along with the specified job ID.

After receiving the notification of the status change, each additional application refers to its own job list 152 and updates the job list only if the status change of the job ID included in the job list 152 is notified. Otherwise, the additional application ignores the notification.

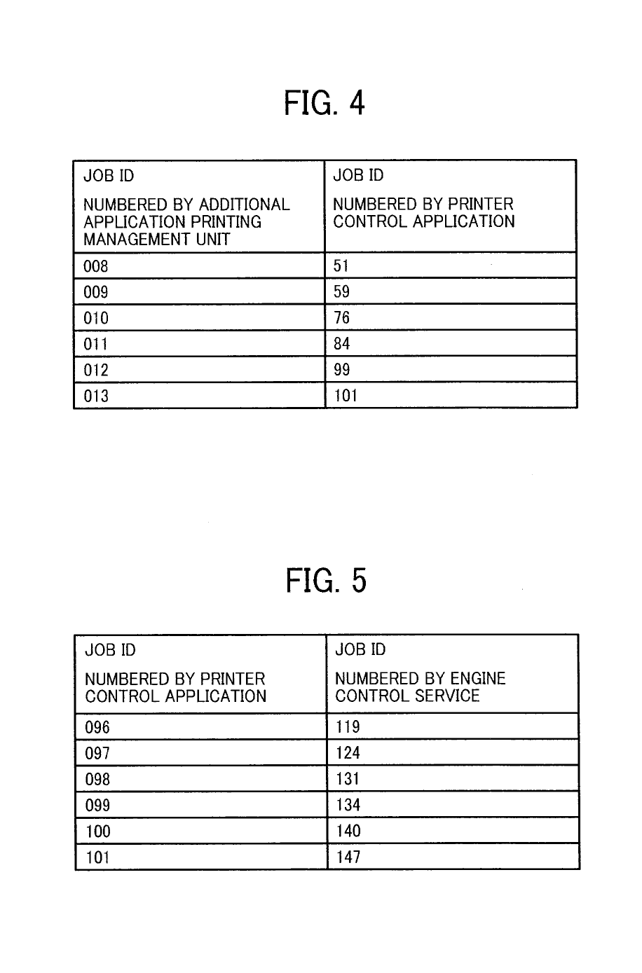

FIG. 4 is a diagram illustrating a job ID associating list 150, and FIG. 5 is a diagram illustrating a job ID associating list 153.

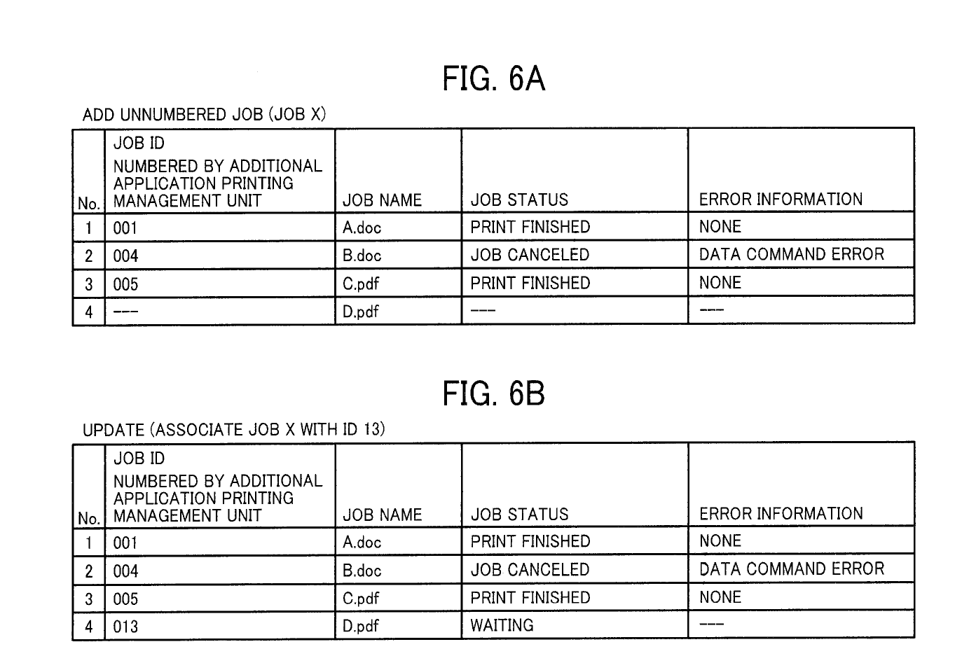

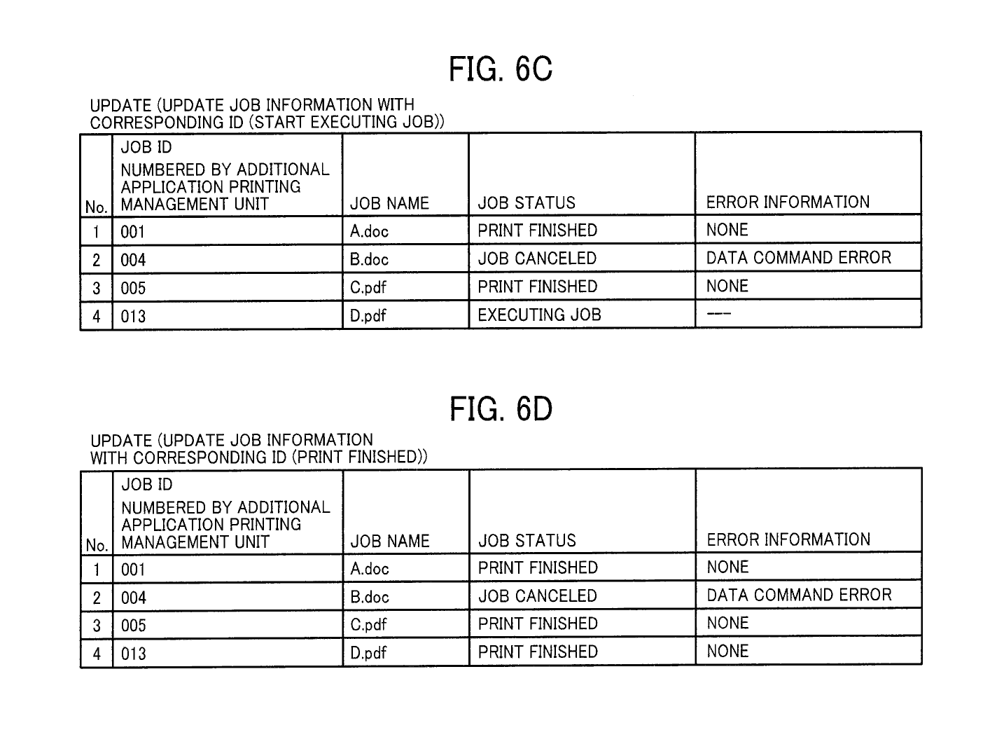

FIGS. 6A, 6B, 6C, and 6D are diagrams illustrating a job list 152. FIGS. 6A, 6B, 6C, and 6D illustrate operations on the job list 152 (adding unnumbered job, updating (associating unnumbered job with the numbered job ID, and reflecting the status change)). Although the number of jobs is four in FIGS. 6A, 6B, 6C, and 6D, the number of jobs is not limited to four, and the additional application can determine the size of its own job list 152 independently.

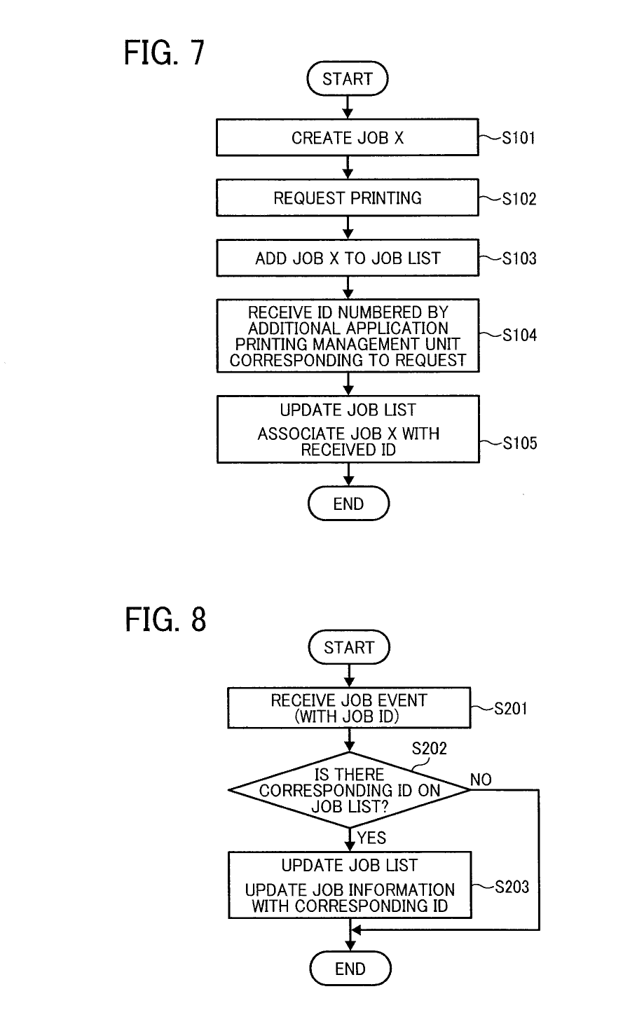

FIG. 7 is a flowchart illustrating processing executed by an additional application related to FIGS. 6A and 6B. After creating a numbered job (job x) in S101, the additional application issues a print request via the additional application interface in S102. Concurrently, the job management unit 151 adds the unnumbered job (job x) to the job list 152 in 5103. FIG. 6A illustrates this status.

After receiving the print request, the job ID in the additional application printing management unit 111 is numbered and notified in S104. Subsequently, the job management unit 151 associates the unnumbered job (job x) with the received job ID and adds them to the job list 152 in S105. FIG. 6B illustrates this status.

FIG. 8 is a flowchart illustrating a process of an additional application related to FIGS. 6C and 6D. The additional application receives a job event along with the job ID in S201. Subsequently, the job management unit 151 determines whether or not the job ID is included in the job list 152 referring to the job list 152 in S202. If the job ID is included in the job list 152, the job list 152 is updated based on the job event in S203. Otherwise, the job event is ignored as described above.

A typical example of the job event in FIG. 8 is the notification of a status change. Information on the job that has the corresponding job ID is updated in S203 as shown in FIGS. 6C and 6D.

With reference to FIG. 1, the additional application printing management unit 111 associates the ID of the job issued by each additional application with the job ID numbered by the default functions as described above, and each additional application includes information on the job issued by itself such as job status in the job list 152. Also, each additional application can utilize the control panel displaying service 134 in the service layer via the service layer interface.

Therefore, information on print jobs can be presented for each additional application. For example, the information can be presented by displaying it on the control panel 144 via the control panel displaying service 134 based on the job list 152, but not limited to that.

Also, even if there is a plurality of additional applications, the additional application printing management unit 111 numbers a unique ID, so identifiers do not overlap and data is categorized correctly.

Also, since the additional application printing management unit 111 can only be used from the area for additional applications 120, that can prevent impersonation.

The main feature of this embodiment is that information on a job that is processed as a default function in the image forming apparatus is acquired timely and managed uniquely (identifying which application issued the job referring to the job information) without using identifiers that distinguish applications and job types by devising numbering of the print job ID and its management.

In other words, the feature described above is that all of the newly added applications that are extract jobs that went through themselves only from trace information on jobs notified by the default functions, and display it in a user interface.

In this embodiment, the additional application can adjust the size of the job list 152 flexibly. That is, the necessary amount of information is stored for each application. Therefore, that can reduce the waste use of memory area, and a large amount of history information can be stored if necessary.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An image forming apparatus, comprising:
a printer control application to control an image forming operation;
an additional application print control unit to submit a print job to the printer control application;
a plurality of additional applications to submit a print job to the additional application print control unit; and
a user interface using service to include an interface available for the additional applications,
wherein each of the additional application comprises a job list that lists jobs submitted to the additional application print control unit and provides information for each job to the user interface via the user interface using service based on the job list, the additional application print control unit numbers a unique ID value for a submitted job, submits the numbered job to the printer control application, associates the numbered job with a job ID of print job managed by the printer control application, receives a job event from the printer control application along with the job ID, and broadcasts the received job event to all of the additional applications along with the job ID associated with the received job ID, and after receiving the job event along with the job ID, each of the plurality of additional applications determines whether or not the received job ID is on the job list, ignores the job event if the received job ID is not on the job list, updates the job list based on the job event if the received job ID is on the job list, and provides information on each job to the user interface via the user interface using service based on the job list.

2. The image forming apparatus according to claim 1, wherein the additional application print control unit associates the numbered job with a job ID of print job managed by the printer control application and stores them in a job ID association list.

3. The image forming apparatus according to claim 1, wherein the additional application adjusts the size of the job list.

4. The image forming apparatus according to claim 1, wherein the user interface is a display unit that comprises a control panel.

5. A method of managing a job, comprising the steps of:
controlling an image forming operation;
submitting a print job to the step of controlling the image forming operation;
submitting a print job that will be submitted to the step of submitting the print job to the step of controlling the image forming operation;
including an interface available for the step of submitting the print job that will be submitted to the step of submitting the print job to the step of controlling the image forming operation;
comprising a job list that lists jobs submitted to the step of submitting the print job to the step of controlling the image forming operation and provides information for each job to the interface via the step of including an interface available for the step of submitting the print job that will be submitted to the step of submitting the print job to the step of controlling the image forming operation based on the job list;
numbering a unique ID value for a submitted job;
submitting the numbered job to the step of controlling an image forming operation;
associating the numbered job with a job ID of print job managed by the step of controlling the image forming operation;
receiving a job event from the step of controlling the image forming operation along with the job ID;
broadcasting the received job event to all of the step of submitting a print job that will be submitted to the step of submitting the print job to the step of controlling the image forming operation along with the job ID associated with the received job ID;
determining whether or not the received job ID is on the job list after receiving the job event along with the job ID;
ignoring the job event if the received job ID is not on the job list after determining whether or not the received job ID is on the job list;
updating the job list based on the job event if the received job ID is on the job list after determining whether or not the received job ID is on the job list;
providing information on each job to the user interface via the step of including an interface available for the step of submitting the print job that will be submitted to the step of submitting the print job to the step of controlling the image forming operation using service based on the job list.

6. A non-transitory recording medium storing a program that, when executed by a computer, causes the computer to implement a method of outputting an image, the method comprising the steps of:
controlling an image forming operation;
submitting a print job to the step of controlling the image forming operation;
submitting a print job that will be submitted to the step of submitting the print job to the step of controlling the image forming operation;
including an interface available for the step of submitting the print job that will be submitted to the step of submitting the print job to the step of controlling the image forming operation;
comprising a job list that lists jobs submitted to the step of submitting the print job to the step of controlling the image forming operation and provides information for each job to the interface via the step of including an interface available for the step of submitting the print job that will be submitted to the step of submitting the print job to the step of controlling the image forming operation based on the job list;
numbering a unique ID value for a submitted job;
submitting the numbered job to the step of controlling an image forming operation;
associating the numbered job with a job ID of print job managed by the step of controlling the image forming operation;
receiving a job event from the step of controlling the image forming operation along with the job ID;
broadcasting the received job event to all the step of submitting a print job that will be submitted to the step of submitting the print job to the step of controlling the image forming operation along with the job ID associated with the received job ID;
determining whether or not the received job ID is on the job list after receiving the job event along with the job ID;
ignoring the job event if the received job ID is not on the job list after determining whether or not the received job ID is on the job list;
updating the job list based on the job event if the received job ID is on the job list after determining whether or not the received job ID is on the job list;
providing information on each job to the user interface via the step of including an interface available for the step of submitting the print job that will be submitted to the step of submitting the print job to the step of controlling the image forming operation using service based on the job list.
